(19) United States
(12) Patent Application Publication
(10) Pub. No.: US 2026/0321686 A1
(43) Pub. Date: Oct. 15, 2026

(54) FUEL CELL STACK

(71) Applicant: TOYOTA JIDOSHA KABUSHIKI KAISHA, Toyota-shi (JP)

(72) Inventors: Daisuke HAYASHI, Miyoshi-shi (JP); Hideyuki ARAI, Seto-shi (JP); Yodai MATSUI, Toyota-shi (JP); Yusuke OTSU, Miyoshi-shi (JP); Kyosuke HAYASHI, Toyota-shi (JP); Takami UMEDA, Miyoshi-shi (JP); Yuto TAMURA, Miyoshi-shi (JP); Makoto TAKEDA, Toyota-shi (JP)

(73) Assignee: TOYOTA JIDOSHA KABUSHIKI KAISHA, Toyota-shi (JP)

(21) Appl. No.: 19/556,456

(22) Filed: Mar. 4, 2026

(30) Foreign Application Priority Data
Apr. 14, 2025 (JP) 2025-066228

(51) Int. Cl. H01M 8/0276; H01M 8/0258

(52) U.S. Cl. CPC H01M 8/0276; H01M 8/0258

(57) ABSTRACT

The fuel cell stack includes a gasket disposed on one main surface of a separator and surrounding a cooling-medium supply hole, a cooling-medium discharge hole, and a cooling-medium flow channel. A region surrounded by the gasket includes a main flow region, a distribution region located between the cooling-medium supply hole and the main flow region, and a collection region located between the cooling-medium discharge hole and the main flow region. The gaskets include either or both of a supply-flow gasket that branches from a distribution-region gasket and extends into the distribution region, and a discharge-flow gasket that branches from the collection-region gasket and extends into the collection region.

### CROSS-REFERENCE TO RELATED APPLICATION

This application claims priority to Japanese Patent Application No. 2025-066228 filed on Apr. 14, 2025. The disclosure of the above-identified application, including the specification, drawings, and claims, is incorporated by reference herein in its entirety.

### BACKGROUND

### 1. Technical Field

The technology disclosed in the present specification relates to fuel cell stacks.

### 2. Description of Related Art

A fuel cell stack includes a cell stack body in which a plurality of fuel cells is stacked in a stacking direction. Each of the fuel cells includes a membrane electrode and gas diffusion layer assembly, and a pair of separators that sandwiches the membrane electrode and gas diffusion layer assembly in the stacking direction.

The separators include an anode separator and a cathode separator. Of a pair of main surfaces of the anode separator, the main surface facing the membrane electrode and gas diffusion layer assembly is provided with a plurality of fuel-gas flow channels. Of a pair of main surfaces of the cathode separator, the main surface facing the membrane electrode and gas diffusion layer assembly is provided with a plurality of oxidant-gas flow channels. A cooling-medium flow channel through which a cooling medium flows is provided on the other main surface of the anode separator and the other main surface of the cathode separator. A gasket is disposed between the other main surface of the anode separator and the other main surface of the cathode separator to seal the cooling-medium flow channel. Japanese Unexamined Patent Application Publication No. 2021-141005 (JP 2021-141005 A) discloses an example of a sealing structure using a gasket.

### SUMMARY

When the in-plane temperature distribution of a fuel cell is observed, a heat spot is located near a cooling-medium discharge hole that communicates with the downstream end of the cooling-medium flow channel. At least part of the cooling medium flowing along a portion of the cooling-medium flow channel adjacent to the gasket (hereinafter referred to as "side flow region") flows into the cooling-medium discharge hole without passing through the heat spot. Such a flow of the cooling medium cannot efficiently cool the heat spot and increases the maximum in-plane temperature of the fuel cell. The present disclosure provides a technique capable of reducing the maximum in-plane temperature of a fuel cell.

A fuel cell stack disclosed in the present specification may include: a separator including a pair of main surfaces and having a cooling-medium supply hole and a cooling-medium discharge hole that extend between the main surfaces, one of the main surfaces being provided with a cooling-medium flow channel; and a gasket disposed on the one of the main surfaces of the separator and surrounding the cooling-medium supply hole, the cooling-medium discharge hole, and the cooling-medium flow channel. A region of the one of the main surfaces of the separator that is surrounded by the gasket may include a main flow region in which the cooling-medium flow channel is provided, a distribution region located between the cooling-medium supply hole and the main flow region, and a collection region located between the cooling-medium discharge hole and the main flow region. The gasket may include: a pair of main-flow-region gaskets disposed adjacent to both sides of the main flow region and extending along a longitudinal direction of the cooling-medium flow channel; a distribution-region gasket disposed adjacent to the distribution region, surrounding part of the periphery of the cooling-medium supply hole, and extending so as to connect the main-flow-region gaskets; a collection-region gasket disposed adjacent to the collection region, surrounding part of the periphery of the cooling-medium discharge hole, and extending so as to connect the main-flow-region gaskets; and a branch gasket. The branch gasket may include either or both of a supply-flow gasket that branches from the distribution-region gasket and extends into the distribution region, and a discharge-flow gasket that branches from the collection-region gasket and extends into the collection region.

The branch gasket can increase the amount of cooling medium that flows to the heat spot located near the cooling-medium discharge hole by controlling the flow of the cooling medium. Accordingly, the fuel cell stack can reduce the maximum in-plane temperature of the fuel cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view of a fuel cell stack;

FIG. 2 is a schematic exploded perspective view of a fuel cell;

FIG. 3 is a schematic diagram showing the configuration of a cooling-medium flow surface of an anode separator;

FIG. 4 is an enlarged view of a region near discharge-flow gaskets, schematically showing the configuration of the discharge-flow gaskets;

FIG. 5 is a diagram showing a heat spot and the flow of a cooling medium flowing along side flow regions in a fuel cell of a comparative example;

FIG. 6 is a diagram showing a heat spot and the flow of a cooling medium flowing along side flow regions in a fuel cell of an embodiment;

FIG. 7 is an enlarged view of a region near discharge-flow gaskets according to a modification, schematically showing the configuration of the discharge-flow gaskets;

FIG. 8 is a diagram schematically showing the configuration of a cooling-medium flow surface of an anode separator; and

FIG. 9 is an enlarged view of a region near supply-flow gaskets, schematically showing the configuration of the supply-flow gaskets.

### DETAILED DESCRIPTION OF EMBODIMENTS

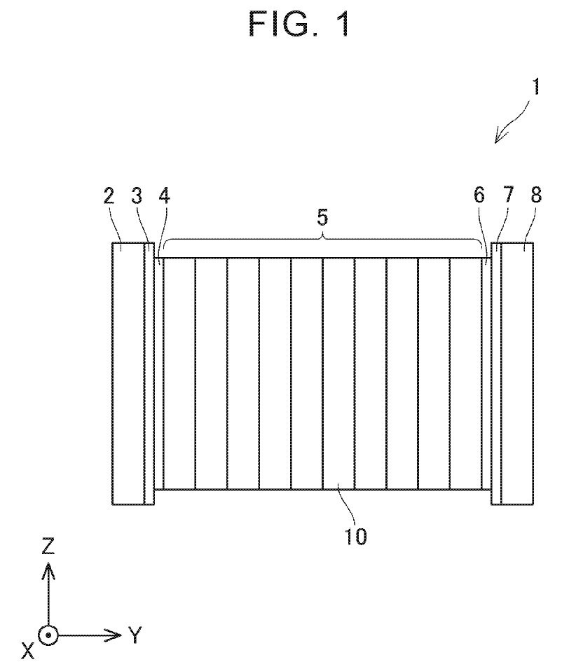

As shown in FIG. 1, a fuel cell stack 1 is a power generation device that generates electric power by causing fuel gas and oxidant gas to undergo a chemical reaction, and includes an anode end plate 2, an anode insulator 3, an anode terminal 4, a cell stack body 5, a cathode terminal 6, a cathode insulator 7, and a cathode end plate 8. The cell stack body 5 includes a plurality of fuel cells 10 stacked in a stacking direction. For example, in the fuel cell stack 1 of the present embodiment, hydrogen gas may be used as the fuel gas, air may be used as the oxidant gas, and water may be used as the cooling medium.

The anode end plate 2 and the cathode end plate 8 are fastened together in the stacking direction by fastening members (not shown). The various components provided between the anode end plate 2 and the cathode end plate 8 are clamped by the anode end plate 2 and the cathode end plate 8.

The anode insulator 3 is an insulator provided between the anode end plate 2 and the anode terminal 4 and electrically insulates the anode end plate 2 from the anode terminal 4. The anode terminal 4 is disposed facing the anode-side end face of the cell stack body 5 in the stacking direction. The anode terminal 4 is an electrically conductive member that functions as a current collector of the cell stack body 5 and is electrically connected to the anode-side end face of the cell stack body 5.

The cathode insulator 7 is an insulator provided between the cathode terminal 6 and the cathode end plate 8 and electrically insulates the cathode terminal 6 from the cathode end plate 8. The cathode terminal 6 is disposed facing the cathode-side end face of the cell stack body 5 in the stacking direction. The cathode terminal 6 is an electrically conductive member that functions as a current collector of the cell stack body 5 and is electrically connected to the cathode-side end face of the cell stack body 5.

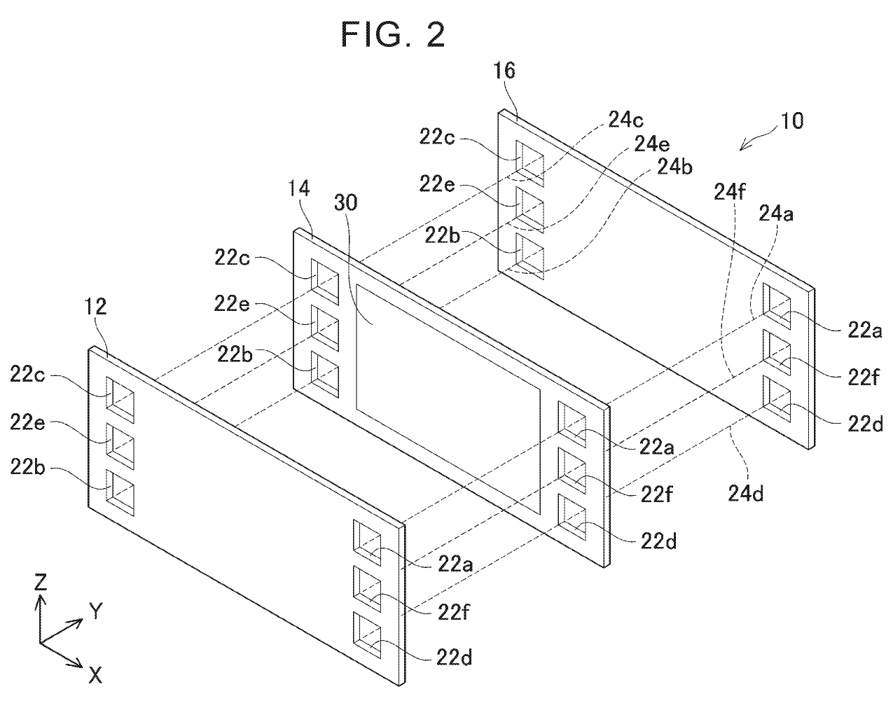

As shown in FIG. 2, each of the fuel cells 10 includes an anode separator 12, a support frame 14, a cathode separator 16, and a membrane electrode and gas diffusion layer assembly (MEGA) 30.

The anode separator 12 is disposed facing the main surface of the MEGA 30 located on the side toward the anode end plate 2 (see FIGS. 1 and 2) out of the pair of main surfaces of the MEGA 30. The cathode separator 16 is disposed facing the main surface of the MEGA 30 located on the side toward the cathode end plate 8 (see FIGS. 1 and 2) out of the pair of main surfaces of the MEGA 30. Each of the separators 12, 16 is a generally rectangular plate-like member, and is formed of a metal base material that is a gas-impermeable, electrically conductive material. The metal base material may be, for example, a stainless-steel base material (an alloy of iron, chromium, and nickel). A surface treatment film for improving corrosion resistance and electrically conductive properties may be formed on part of the main surface of the metal base material.

The support frame 14 is a frame-shaped structure that supports the MEGA 30. The support frame 14 is made of a gas-impermeable insulating material such as a resin material. The support frame 14 is sandwiched between the anode separator 12 and the cathode separator 16.

Each of the separators 12, 16 and the support frame 14 has six through holes 22a to 22f extending between its pair of main surfaces. The six through holes 22a to 22f include a first supply hole 22a, a first discharge hole 22b, a second supply hole 22c, a second discharge hole 22d, a third supply hole 22e, and a third discharge hole 22f. The first supply hole 22a is a fuel-gas supply hole, the first discharge hole 22b is a fuel-gas discharge hole, the second supply hole 22c is an oxidant-gas supply hole, the second discharge hole 22d is an oxidant-gas discharge hole, the third supply hole 22e is a cooling-medium supply hole, and the third discharge hole 22f is a cooling-medium discharge hole. However, the present disclosure is not particularly limited to this. The six through holes 22a to 22f are arranged at both longitudinal ends of each of the separators 12, 16 and the support frame 14. Three through holes 22a, 22c, 22e are arranged at a first longitudinal end, and the other three through holes 22b, 22d, 22f are arranged at a second longitudinal end.

When the fuel cells 10 are stacked in the stacking direction, the first supply holes 22a formed in the separators 12, 16 and the support frame 14 are connected to each other to form a first supply manifold 24a. Similarly, the second supply holes 22c, the third supply holes 22e, the first discharge holes 22b, the second discharge holes 22d, and the third discharge holes 22f form a second supply manifold 24c, a third supply manifold 24e, a first discharge manifold 24b, a second discharge manifold 24d, and a third discharge manifold 24f, respectively. That is, the cell stack body 5 of the fuel cell stack 1 has six manifolds 24a to 24f extending along the stacking direction.

The fuel gas is supplied from the first supply manifold 24a to each fuel cell 10. In each fuel cell 10, fuel-gas flow channels are formed on one main surface of the anode separator 12 (that is, the surface facing the MEGA 30, also referred to as the "gas flow surface") such that fuel gas flows between the anode separator 12 and the MEGA 30. The fuel gas that has passed through each fuel cell 10 is discharged to the outside of the fuel cell stack 1 through the first discharge manifold 24b.

The oxidant gas is supplied from the second supply manifold 24c to each fuel cell 10. In each fuel cell 10, oxidant-gas flow channels are formed on one main surface of the cathode separator 16 (that is, the surface facing the MEGA 30, also referred to as the "gas flow surface") such that oxidant gas flows between the cathode separator 16 and the MEGA 30. The oxidant gas that has passed through each fuel cell 10 is discharged to the outside of the fuel cell stack 1 through the second discharge manifold 24d.

The cooling medium is supplied from the third supply manifold 24e to each fuel cell 10. In each fuel cell 10, a cooling-medium flow channel is formed between the anode separator 12 of one fuel cell 10 and the cathode separator 16 of an adjacent fuel cell 10 such that the cooling medium flows between the adjacent fuel cells 10 in the stacking direction. The cooling medium that has passed between the fuel cells 10 is discharged to the outside of the fuel cell stack 1 through the third discharge manifold 24f.

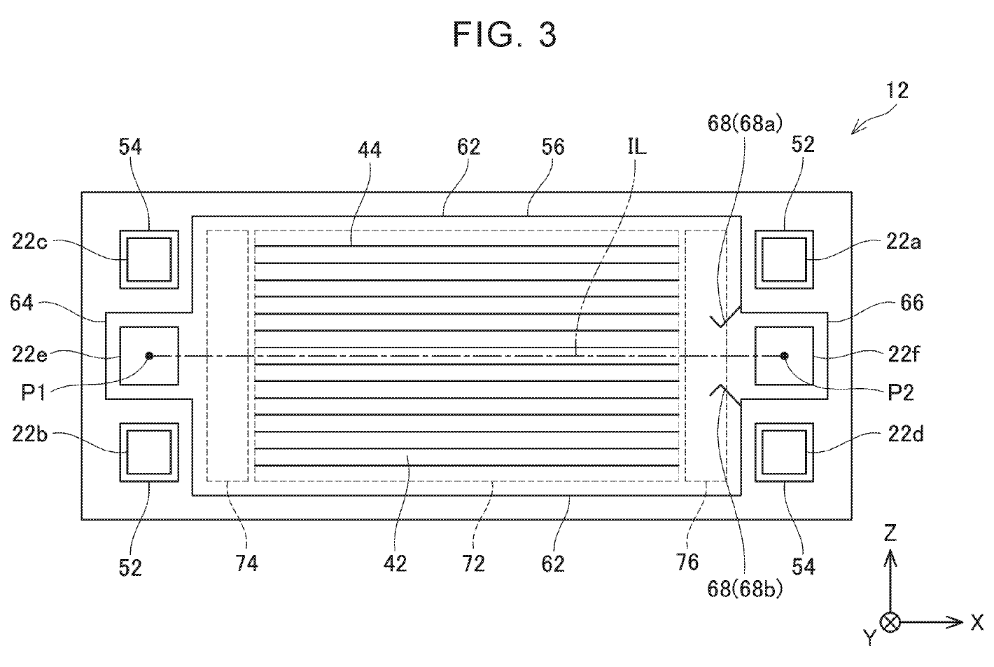

FIG. 3 shows a cooling-medium flow surface of the anode separator 12. The cooling-medium flow surface herein refers to one of the pair of main surfaces of the anode separator 12 that is located on the opposite side from the gas flow surface. The cooling-medium flow surface of the anode separator 12 will now be described as an example. Alternatively, a similar configuration may be provided on a cooling-medium flow surface of the cathode separator 16.

A cooling-medium flow channel 42 is provided on the cooling-medium flow surface of the anode separator 12. An upstream end of the cooling-medium flow channel 42 communicates with the third supply hole 22e. A downstream end of the cooling-medium flow channel 42 communicates with the third discharge hole 22f. The cooling-medium flow channel 42 extends in a direction connecting the third supply hole 22e and the third discharge hole 22f, that is, along the longitudinal direction of the anode separator 12. The cooling-medium flow channel 42 is provided with an uneven structure 44. The uneven structure 44 has a plurality of protrusions that extends linearly along the longitudinal direction of the cooling-medium flow channel 42. The protrusions correspond to the outer peripheral surfaces of the fuel-gas flow channels provided on the gas-flow surface of the anode separator 12. The uneven structure 44 is disposed so as to include a power generation region when viewed from the stacking direction. The "power generation region" herein refers to a region that corresponds to the position of the MEGA 30 when viewed in the stacking direction.

Fuel-gas sealing gaskets 52, oxidant-gas sealing gaskets 54, and a cooling-medium sealing gasket 56 are disposed on the cooling-medium flow surface of the anode separator 12. The fuel-gas sealing gaskets 52 annularly surround the first supply hole 22a and the first discharge hole 22b, respectively. The oxidant-gas sealing gaskets 54 annularly surround the second supply hole 22c and the second discharge hole 22d, respectively. The cooling-medium sealing gasket 56 annularly surrounds the third supply hole 22e, the third discharge hole 22f, and the cooling-medium flow channel 42. The gaskets 52, 54, 56 are made of an elastic material such as rubber or a thermoplastic elastomer. Each of the gaskets 52, 54, 56 is clamped between the anode separator 12 and the cathode separator 16 under a pressing force in the stacking direction.

Of the cooling-medium flow surface of the anode separator 12, a region surrounded by the cooling-medium sealing gasket 56 includes a main flow region 72, a distribution region 74, and a collection region 76. The main flow region 72 is a region that corresponds to the power generation region when viewed from the stacking direction. In other words, the main flow region 72 may be a region in which the uneven structure 44 is provided. The cooling medium flowing through the main flow region 72 flows along a direction parallel to the direction connecting the third supply hole 22e and the third discharge hole 22f.

The distribution region 74 is a region between the third supply hole 22e and the main flow region 72. The cooling medium flowing through the distribution region 74 flows radially from the third supply hole 22e toward the main flow region 72. The distribution region 74 may or may not be provided with a structure that promotes distribution of the cooling medium, such as an uneven structure.

The collection region 76 is a region between the third discharge hole 22f and the main flow region 72. The cooling medium flowing through the collection region 76 converges counter-radially from the main flow region 72 and flows into the third discharge hole 22f. The collection region 76 may or may not be provided with a structure that promotes collection of the cooling medium, such as an uneven structure.

The cooling-medium sealing gasket 56 includes a pair of main-flow-region gaskets 62, a distribution-region gasket 64, a collection-region gasket 66, and a pair of discharge-flow gaskets 68.

The main-flow-region gaskets 62 are gasket portions that constitute part of the cooling-medium sealing gasket 56 and are gasket portions disposed adjacent to both sides of the main flow region 72. The main-flow-region gaskets 62 may extend linearly along the longitudinal direction of the cooling-medium flow channel 42.

The distribution-region gasket 64 is a gasket portion that constitutes part of the cooling-medium sealing gasket 56 and is a gasket portion that extends so as to connect the main-flow-region gaskets 62. The distribution-region gasket 64 is disposed adjacent to the distribution region 74 and surrounds part of the periphery of the third supply hole 22e. More specifically, the distribution-region gasket 64 includes: portions that extend along the longitudinal direction of the anode separator 12 and are disposed adjacent to both sides of the distribution region 74; portions that extend along the lateral direction of the anode separator 12 and are disposed adjacent to the distribution region 74; and a portion that annularly surrounds part of the periphery of the third supply hole 22e on the side opposite from the distribution region 74.

The collection-region gasket 66 is a gasket portion that constitutes part of the cooling-medium sealing gasket 56 and is a gasket portion that extends so as to connect the main-flow-region gaskets 62. The collection-region gasket 66 is disposed adjacent to the collection region 76 and surrounds part of the periphery of the third discharge hole 22f. More specifically, the collection-region gasket 66 includes: portions that extend along the longitudinal direction of the anode separator 12 and are disposed adjacent to both sides of the collection region 76; portions that extend along the lateral direction of the anode separator 12 and are disposed adjacent to the collection region 76; and a portion that annularly surrounds part of the periphery of the third discharge hole 22f on the side opposite from the collection region 76.

Each of the discharge-flow gaskets 68 is a gasket portion that constitutes part of the cooling-medium sealing gasket 56 and is a gasket portion that branches from the collection-region gasket 66 and extends into the collection region 76. The discharge-flow gaskets 68 are also referred to as branch gaskets. An imaginary line IL is defined that connects a geometric center P1 of the third supply hole 22e and a geometric center P2 of the third discharge hole 22f when the anode separator 12 is viewed in plan. The discharge-flow gaskets 68 include a first discharge-flow gasket 68a disposed on one side of the imaginary line IL (in other words, on the upper side in the vertical direction when in use) and a second discharge-flow gasket 68b disposed on the other side of the imaginary line IL (in other words, on the lower side in the vertical direction when in use). Alternatively, one of the discharge-flow gaskets 68 may be provided.

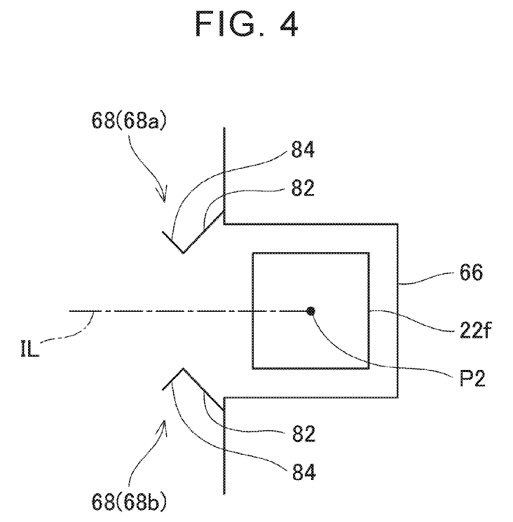

As shown in FIG. 4, each of the first discharge-flow gasket 68a and the second discharge-flow gasket 68b includes a first discharge-flow portion 82 extending from the collection-region gasket 66 and a second discharge-flow portion 84 extending from the first discharge-flow portion 82. The first discharge-flow portion 82 has a first end connected to the collection-region gasket 66 and a second end connected to the second discharge-flow portion 84. The first discharge-flow portion 82 extends toward the main flow region 72 and the imaginary line IL. The second discharge-flow portion 84 has a first end connected to the first discharge-flow portion 82 and a second end that is a free end. The second discharge-flow portion 84 extends toward the main flow region 72 and away from the imaginary line IL. Each of the first discharge-flow gasket 68a and the second discharge-flow gasket 68b may be linear or may be curved.

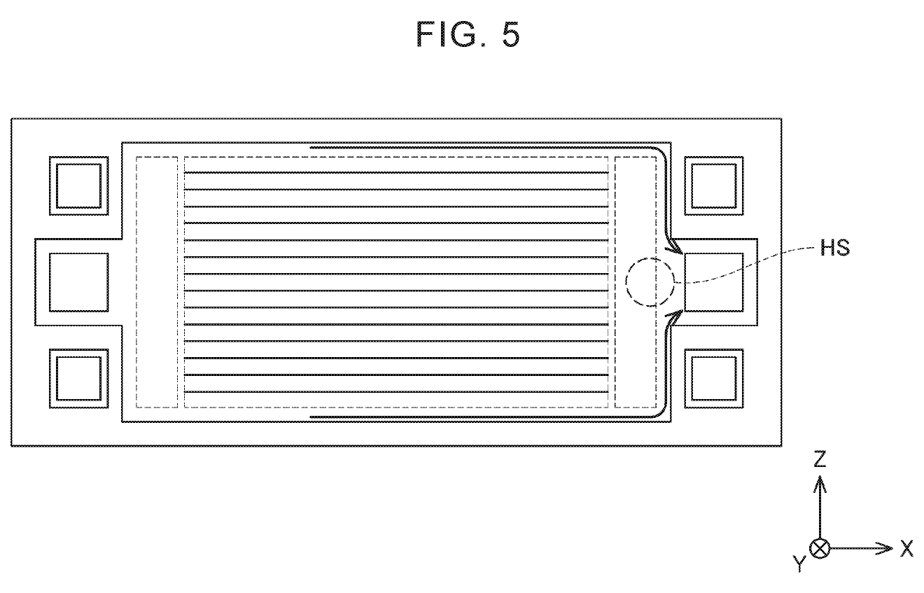

FIG. 5 shows the position of a heat spot HS in an in-plane temperature distribution of a fuel cell in a comparative example in which the discharge-flow gaskets 68 are not provided. The heat spot HS is located near the third discharge hole 22f. FIG. 5 also shows, by continuous arrows, the flow of the cooling medium along side flow regions adjacent to the cooling-medium sealing gasket 56. As shown in FIG. 5, the cooling medium flowing along the side flow regions flows into the third discharge hole 22f without passing through the heat spot HS. If the amount of cooling medium flowing through the side flow regions is large, the heat spot HS cannot be cooled effectively, and the maximum in-plane temperature of the fuel cell increases.

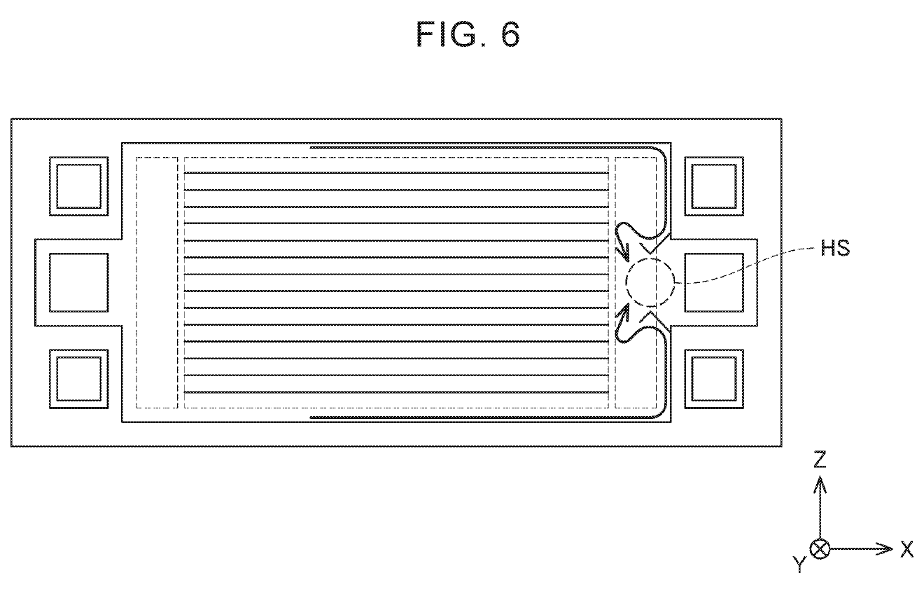

FIG. 6 shows the position of the heat spot HS and the flow of the cooling medium along the side flow regions in the present embodiment. The cooling medium that has flowed along the side flow regions is guided to the heat spot HS with its flow controlled by the discharge-flow gaskets 68. Accordingly, the temperature of the heat spot HS can be reduced. In the present embodiment, the maximum in-plane temperature of the fuel cell is reduced.

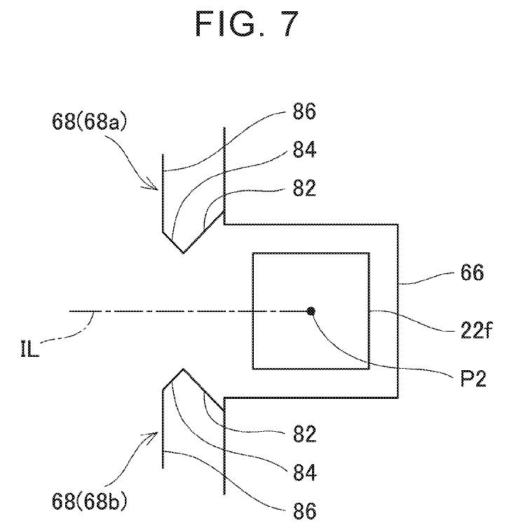

Each of the discharge-flow gaskets 68 shown in FIG. 7 further includes a third discharge-flow portion 86 extending from the second discharge-flow portion 84. The third discharge-flow portion 86 has a first end connected to the second discharge-flow portion 84 and a second end that is a free end. The third discharge-flow portion 86 extends away from the imaginary line IL. The third discharge-flow portion 86 may extend toward the main flow region 72 or may extend away from the main flow region 72. In this example as well, the cooling medium that has flowed along the side flow regions is guided to the heat spot HS by the discharge-flow gaskets 68. Accordingly, the temperature of the heat spot HS can be reduced. In the present embodiment, the maximum in-plane temperature of the fuel cell is reduced.

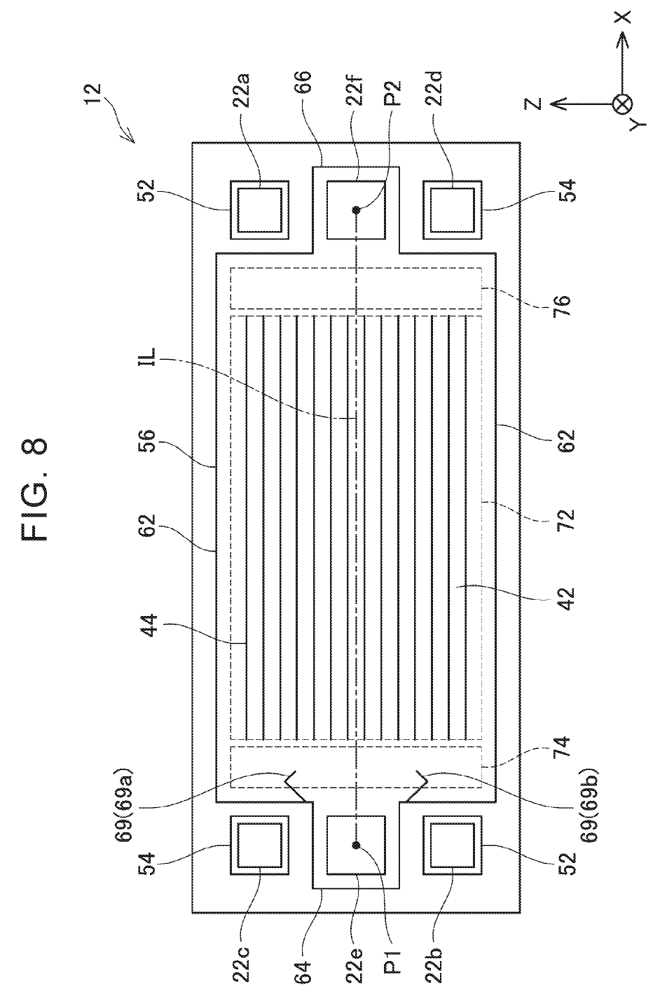

FIG. 8 shows an example in which a pair of supply-flow gaskets 69 is provided instead of the discharge-flow gaskets 68. Both the discharge-flow gaskets 68 and the supply-flow gaskets 69 may be provided.

Each of the supply-flow gaskets 69 is a gasket portion that constitutes part of the cooling-medium sealing gasket 56 and is a gasket portion that branches from the distribution-region gasket 64 and extends into the distribution region 74. The supply-flow gaskets 69 are also referred to as branch gaskets. The supply-flow gaskets 69 include a first supply-flow gasket 69a disposed on one side of the imaginary line IL (in other words, on the upper side in the vertical direction when in use) and a second supply-flow gasket 69b disposed on the other side of the imaginary line IL (in other words, on the lower side in the vertical direction when in use). Alternatively, one of the supply-flow gaskets 69 may be provided.

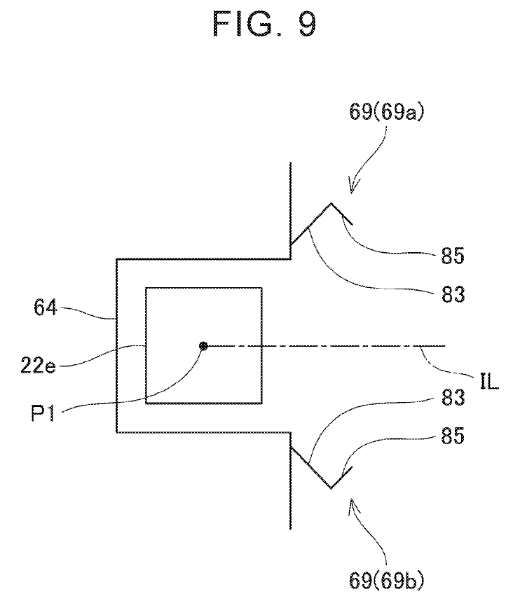

As shown in FIG. 9, each of the first supply-flow gasket 69a and the second supply-flow gasket 69b includes a first supply-flow portion 83 extending from the distribution-region gasket 64 and a second supply-flow portion 85 extending from the first supply-flow portion 83. The first supply-flow portion 83 has a first end connected to the distribution-region gasket 64 and a second end connected to the second supply-flow portion 85. The first supply-flow portion 83 extends toward the main flow region 72 and away from the imaginary line IL. The second supply-flow portion 85 has a first end connected to the first supply-flow portion 83 and a second end that is a free end. The second supply-flow portion 85 extends toward the main flow region 72 and the imaginary line IL. Each of the first supply-flow gasket 69a and the second supply-flow gasket 69b may be linear or may be curved.

In the case where the supply-flow gaskets 69 are provided, the amount of cooling medium guided into the side flow regions is decreased, and therefore the amount of cooling medium flowing to the heat spot is relatively increased. Accordingly, the temperature of the heat spot can be reduced. In the present embodiment, the maximum in-plane temperature of the fuel cell is reduced.

The aspects disclosed in the present specification are summarized below. The technical elements described below are each independent technical elements and exhibit technical utility either individually or in various combinations.

### First Aspect

A fuel cell stack including:
a separator including a pair of main surfaces and having a cooling-medium supply hole and a cooling-medium discharge hole that extend between the main surfaces, one of the main surfaces being provided with a cooling-medium flow channel; and
a gasket disposed on the one of the main surfaces of the separator and surrounding the cooling-medium supply hole, the cooling-medium discharge hole, and the cooling-medium flow channel, wherein:
a region of the one of the main surfaces of the separator that is surrounded by the gasket includes a main flow region, a distribution region located between the cooling-medium supply hole and the main flow region, and a collection region located between the cooling-medium discharge hole and the main flow region;
the gasket includes
a pair of main-flow-region gaskets disposed adjacent to both sides of the main flow region and extending along a longitudinal direction of the cooling-medium flow channel,
a distribution-region gasket disposed adjacent to the distribution region, surrounding part of the periphery of the cooling-medium supply hole, and extending so as to connect the main-flow-region gaskets,
a collection-region gasket disposed adjacent to the collection region, surrounding part of the periphery of the cooling-medium discharge hole, and extending so as to connect the main-flow-region gaskets, and
a branch gasket; and
the branch gasket includes either or both of a supply-flow gasket that branches from the distribution-region gasket and extends into the distribution region, and a discharge-flow gasket that branches from the collection-region gasket and extends into the collection region.

### Second Aspect

The fuel cell stack according to the first aspect, wherein:
the branch gasket includes the discharge-flow gasket; and
in a plan view of the separator in which an imaginary line connecting the geometric center of the cooling-medium supply hole and the geometric center of the cooling-medium discharge hole is defined, the discharge-flow gasket includes
a first portion that extends from the collection-region gasket toward the main flow region and the imaginary line, and
a second portion that extends from the first portion toward the main flow region and away from the imaginary line.

### Third Aspect

The fuel cell stack according to the second aspect, wherein the discharge-flow gasket further includes a third portion that extends from the second portion away from the imaginary line.

### Fourth Aspect

The fuel cell stack according to any one of the first to third aspects, wherein:
the branch gasket includes the supply-flow gasket; and
in a plan view of the separator in which an imaginary line connecting the geometric center of the cooling-medium supply hole and the geometric center of the cooling-medium discharge hole is defined, the supply-flow gasket includes:
a first portion that extends from the distribution-region gasket toward the main flow region and away from the imaginary line, and
a second portion that extends from the first portion toward the main flow region and the imaginary line.

### Fifth Aspect

The fuel cell stack according to any one of the first to fourth aspect, wherein, in a plan view of the separator in which an imaginary line connecting the geometric center of the cooling-medium supply hole and the geometric center of the cooling-medium discharge hole is defined, the branch gasket includes:
a first branch gasket disposed on one side of the imaginary line, and
a second branch gasket disposed on the other side of the imaginary line.

Although some specific examples have been described in detail above, these are merely illustrative and are not intended to limit the scope of the claims. The technology described in the claims includes various modifications and alterations of the specific examples illustrated above. The technical elements described in the present specification or illustrated in the drawings exhibit technical utility either individually or in combinations.

What is claimed is:

1. A fuel cell stack comprising:
a separator including a pair of main surfaces and having a cooling-medium supply hole and a cooling-medium discharge hole that extend between the main surfaces, one of the main surfaces being provided with a cooling-medium flow channel; and
a gasket disposed on the one of the main surfaces of the separator and surrounding the cooling-medium supply hole, the cooling-medium discharge hole, and the cooling-medium flow channel, wherein:
a region of the one of the main surfaces of the separator that is surrounded by the gasket includes a main flow region, a distribution region located between the cooling-medium supply hole and the main flow region, and a collection region located between the cooling-medium discharge hole and the main flow region;
the gasket includes
a pair of main-flow-region gaskets disposed adjacent to both sides of the main flow region and extending along a longitudinal direction of the cooling-medium flow channel,
a distribution-region gasket disposed adjacent to the distribution region, surrounding part of a periphery of the cooling-medium supply hole, and extending so as to connect the main-flow-region gaskets,
a collection-region gasket disposed adjacent to the collection region, surrounding part of a periphery of the cooling-medium discharge hole, and extending so as to connect the main-flow-region gaskets, and
a branch gasket; and
the branch gasket includes either or both of a supply-flow gasket that branches from the distribution-region gasket and extends into the distribution region, and a discharge-flow gasket that branches from the collection-region gasket and extends into the collection region.

2. The fuel cell stack according to claim 1, wherein:
the branch gasket includes the discharge-flow gasket; and
in a plan view of the separator in which an imaginary line connecting a geometric center of the cooling-medium supply hole and a geometric center of the cooling-medium discharge hole is defined, the discharge-flow gasket includes
a first portion that extends from the collection-region gasket toward the main flow region and the imaginary line, and
a second portion that extends from the first portion toward the main flow region and away from the imaginary line.

3. The fuel cell stack according to claim 2, wherein the discharge-flow gasket further includes a third portion that extends from the second portion away from the imaginary line.

4. The fuel cell stack according to claim 1, wherein:
the branch gasket includes the supply-flow gasket; and
in a plan view of the separator in which an imaginary line connecting a geometric center of the cooling-medium supply hole and a geometric center of the cooling-medium discharge hole is defined, the supply-flow gasket includes
a first portion that extends from the distribution-region gasket toward the main flow region and away from the imaginary line, and
a second portion that extends from the first portion toward the main flow region and the imaginary line.

5. The fuel cell stack according to claim 1, wherein, in a plan view of the separator in which an imaginary line connecting a geometric center of the cooling-medium supply hole and a geometric center of the cooling-medium discharge hole is defined, the branch gasket includes
a first branch gasket disposed on one side of the imaginary line, and
a second branch gasket disposed on the other side of the imaginary line.
